(19) United States
(12) Patent Application Publication
(10) Pub. No.: US 2010/0156321 A1
(43) Pub. Date: Jun. 24, 2010

(54) Lamp Driving Device

(75) Inventors: Teng-Kang CHANG, Zhubei City (TW); Feng-Pin LEE, Zhubei City (TW)

Correspondence Address: HDLS IPR Services, PO Box 220746, Chantilly, VA, 20153, US

(73) Assignee: Logah Technology Corp.

(21) Appl. No.: 12/616,644

(22) Filed: Nov. 11, 2009

(30) Foreign Application Priority Data
Dec. 23, 2008 (TW) 097223052

(51) Int. Cl. H05B 37/02

(52) U.S. Cl. 315/297

(57) ABSTRACT

A lamp driving device includes a DC power supply, a square wave switch, a square wave controller, a plurality of lamps, a starting transformer, and a common transformer; a plurality of starting transformers and a plurality of common transformers are disposed at both sides of the plurality of lamps respectively, the plurality of starting transformers and the plurality of common transformers can have their primary sides or secondary sides cascaded and connected to the square wave switch; the present invention can effectively control the output power to the lamps, reduce the size and the temperature of the device, and improve the overall efficiency by connecting the primary sides or secondary sides in series.

### BACKGROUND OF THE INVENTION

1. Field of the Invention

The present invention relates to a lamp driving device, and more particularly, to a lamp driving device which can equally distribute the output power to lamps.

2. Description of the Prior Art

Please refer to FIG. 1 for a structural view of a conventional lamp driving device which includes a DC power supply 12 disposed at one side of a plurality of lamps 11. The DC power supply 12 provides DC power to a square wave switch 13, the square wave switch 13 receives a control signal from a square wave controller 14 and provides a square wave signal to a starting transformer 15 and a common transformer 16, the starting transformer 15 and the common transformer 16 output signals via high voltage capacitive elements 17 to drive the lamps 11, thereby maintaining uniform brightness among the plurality of lamps 11. In the conventional device, filtering based on the leakage inductance and the harmonic oscillation of the secondary side of the transformer are important factors in designing the lamp driving device, therefore high leakage inductance and high wattage are required in implementing the transformers; however, problems arise such as higher leakage inductance leading to worse coupling efficiency, high turn ratio increasing the intrinsic resistance, and also high wattage leading to higher temperature rising of the transformer. Besides, high wattage transformers tend to be bulky and is not applicable in thin profile device.

Please refer to FIG. 2 for a structural view of another conventional lamp driving device which includes a DC power supply 22 disposed at one side of a plurality of lamps 21. The DC power supply 22 provides DC power to a square wave switch 23, the square wave switch 23 receives a control signal from a square wave controller 24 and provides a square wave signal to a plurality of starting transformers 25 and a plurality of common transformers 26, the plurality of starting transformers 25 and the plurality of common transformers 26 output signals via high voltage capacitive elements 27 to drive the lamps 21, thereby maintaining uniform brightness among the plurality of lamps 21. In the conventional device, a plurality of transformers are connected in parallel to reduce the temperature of the transformers and to replace one bulky transformer; however, each transformer could have different temperature rising when a plurality of transformers are connected in parallel due to different output power of the transformers.

### SUMMARY OF THE INVENTION

It is an object of the present invention to provide a lamp driving device which can make transformers thinner and reduce production cost.

It is another object of the present invention to provide a lamp driving device which can effectively control the output power to lamps, lets the lamps have less difference in temperature rising, and enhance overall efficiency.

In order to achieve the above objects, the present invention provides a lamp driving device comprising a DC power supply, a square wave switch, a square wave controller, a plurality of lamp, a starting transformer, and a common transformer; a plurality of starting transformers and a plurality of common transformers are disposed at both sides of the plurality of lamps respectively, the plurality of starting transformers and the plurality of common transformers can have both ends connected to the square wave switch; the square wave switch connects to the DC power supply and receives a control signal from the square wave controller.

### BRIEF DESCRIPTION OF THE DRAWINGS

FIG. 1 illustrates a structural view of a prior-art lamp driving device in the present invention;

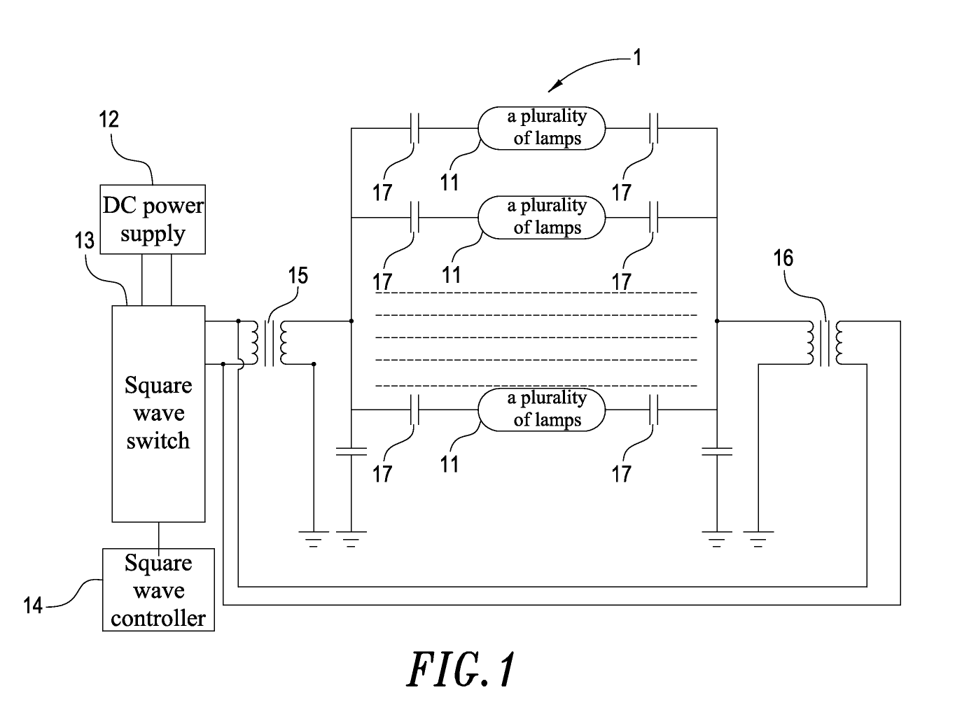

FIG. 2 illustrates another structural view of a prior-art lamp driving device in the present invention;

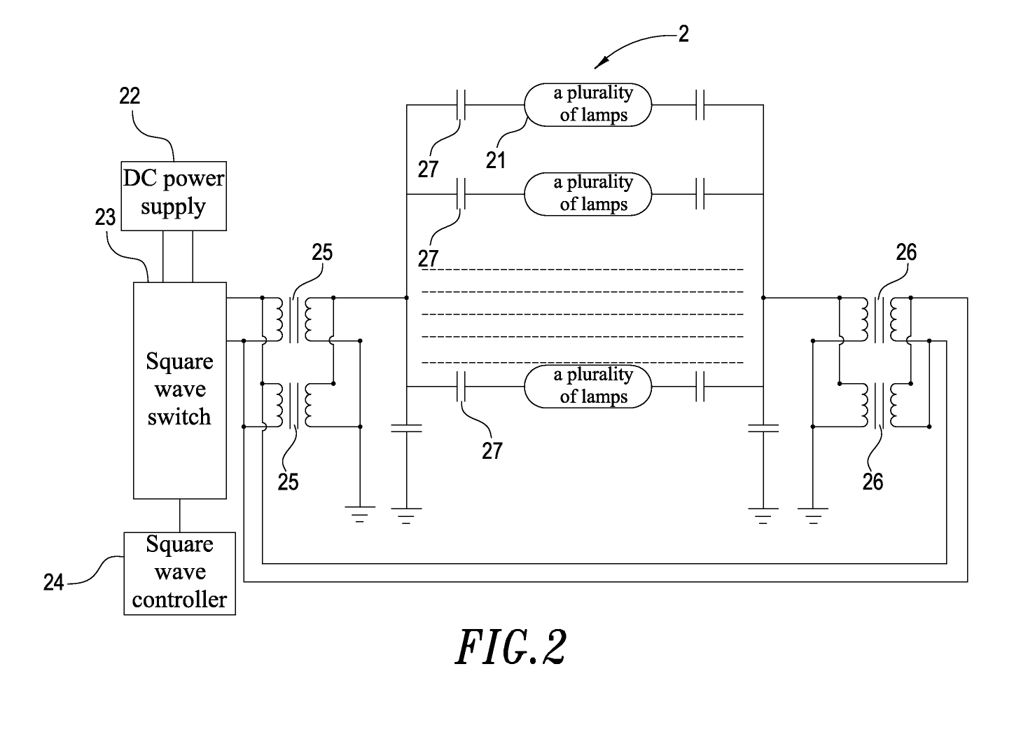

FIG. 3 illustrates a circuit diagram of a lamp driving device in a first embodiment of the present invention; and

FIG. 4 illustrates a circuit diagram of the lamp driving device in a second embodiment of the present invention.

### DETAILED DESCRIPTION OF THE PREFERRED EMBODIMENT

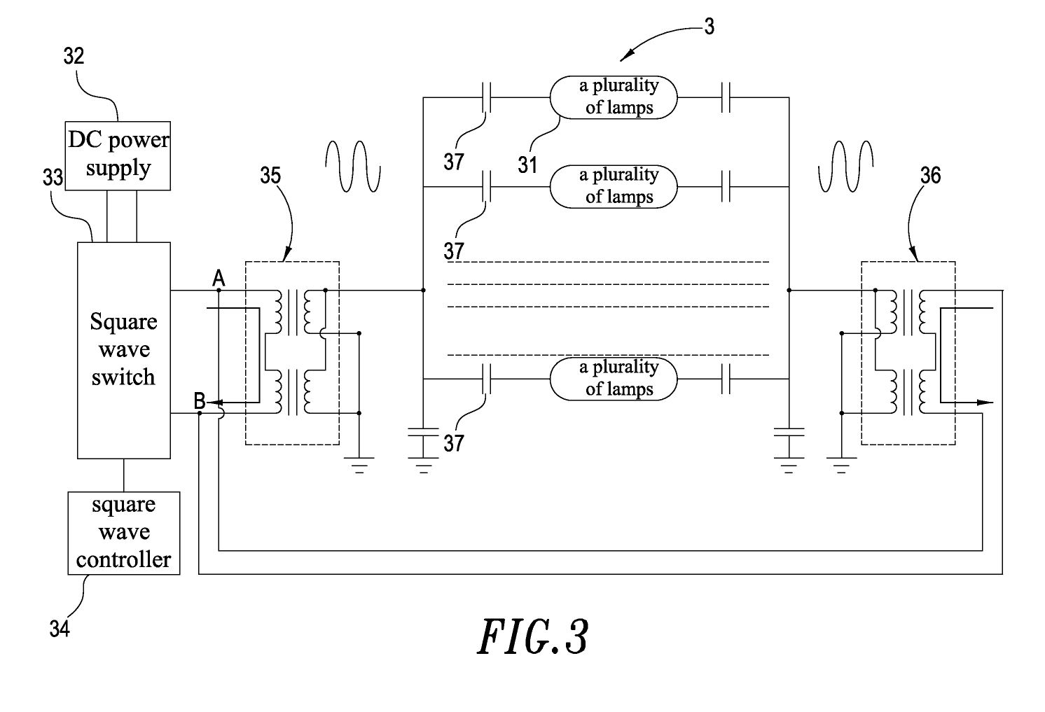

Please refer to FIG. 3 for a circuit diagram of a lamp driving device in a first embodiment of the present invention. From the figure; the present invention discloses a lamp driving device 3, which comprises:

a DC power supply 32 for outputting an DC signal to a square wave switch 33;

a square wave switch 33 for converting the DC signal provided by the DC power supply 32 into an AC signal and outputting the AC signal to a plurality of starting transformers 35 and a plurality of common transformers 36;

a square wave controller 34 for outputting a control signal to the square wave switch 33;

a plurality of lamps 31 each having two ends coupled with the plurality of starting transformers 35 and the plurality of common transformers 36 respectively via high voltage capacitive elements 37;

the plurality of starting transformer 35 having their primary sides connected in series, the square wave switch outputting the AC signal from contacts A, B to the two ends of the primary sides of the cascaded starting transformers 35, the secondary sides of the starting transformers 35 each having a first end connecting to high voltage capacitive elements (to drive the lamps) and a first capacitor and outputting a sinusoidal wave, and a second end connecting to a reference voltage level; when the primary sides of the starting transformers 35 are connected in series, a same input current will flow through the primary sides of the starting transformers 35; since the primary side and the secondary side of each starting transformer 35 have the same turn ratio, therefore a same output current will flow out of each secondary side of the starting transformers; and

the plurality of common transformers 36 having their primary sides connected in series, the square wave switch outputting the AC signal from the contacts A, B to the two ends of the primary sides of the cascaded common transformers 36, the secondary sides of the common transformers 36 each having a first end connecting to high voltage capacitive elements (to drive the lamps) and a second capacitor and outputting an inverse sinusoidal wave, and a second end connecting to the reference voltage level; when the primary sides of the common transformers 36 are connected in series, a same input current will flow through the primary sides of the starting transformers; since the primary side and the secondary side of each common transformer 35 have the same turn ratio, therefore a same output current will flow out of each secondary side of the starting transformers 36.

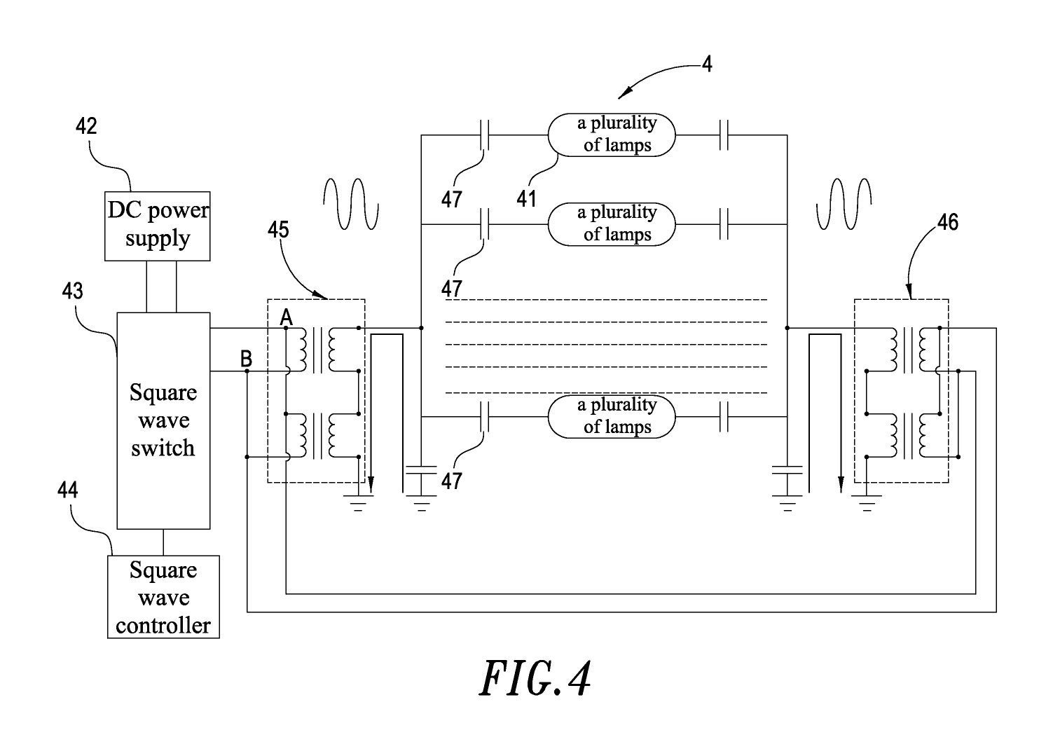

Please refer to FIG. 4 for a circuit diagram of a lamp driving device in a second embodiment of the present invention. From the figure; the present invention discloses a lamp driving device 4, which comprises:

a DC power supply 42 for outputting an DC signal to a square wave switch 43;

a square wave switch 43 for converting the DC signal provided by the DC power supply 42 into an AC signal and outputting the AC signal to a plurality of starting transformers 45 and a plurality of common transformers 46;
a square wave controller 44 for outputting a control signal to the square wave switch 43;
a plurality of lamps 41 h having two ends coupled with the plurality of starting transformers 45 the plurality of common transformers 46 pectively via high voltage capacitive elements 47 the plurality of starting transformers 45 having their secondary sides connected in series,
   wherein a first end of a secondary side of a first starting transformer 45 connects to high voltage capacitive elements 47 (to drive the lamps) and a first capacitor and outputs a sinusoidal wave, a first end of a secondary side of a last starting transformer 45 connects to a reference voltage level, and the primary sides of the starting transformers 45 are connected in parallel and are connected to the square wave switch via contacts A, B, which outputs the AC signal to the two ends of the primary sides of the starting transformers 45, since the secondary sides of the starting transformers 45 are connected in series; therefore each starting transformer outputs a similar amount of power; and

the plurality of common transformers 46 having their secondary sides connected in series, wherein a first end of a secondary side of a first common transformer 46 connects to high voltage capacitive elements (to drive the lamps) and a second capacitor and outputs an inverse sinusoidal wave, a first end of a secondary side of a last common transformer 46 connects to a reference voltage level, and the primary sides of the common transformers 46 are connected in parallel and are connected to the square wave switch via the contacts A, B, which outputs the AC signal to the two ends of the primary sides of the common transformers 46, since the secondary sides of the common transformers 46 are connected in series; therefore each common transformer outputs a similar amount of power.

The present invention provides a lamp driving device, while compared to other prior art techniques, is advantageous in:

1. The present invention provides a lamp driving device which can effectively control the output power to make transformers thinner and reduce temperature rising.

2. The present invention provides a lamp driving device which uses small transformers connected in series to reduce the output power of each transformer; which helps to reduce the size of the device (since the total volume of the plurality of transformer is still smaller than one bulky transformer) and to lower the production cost.

3. The implementation of the lamp driving device can have a same current flowed through each transformer and obtain similar output power from each transformer, thereby improving the total efficiency from 74% in the prior art to 80% in the present invention.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A lamp driving device, comprising:
a DC power supply for outputting an DC signal to a square wave switch;
the square wave switch for converting the DC signal into an AC signal and outputting the AC signal to a plurality of starting transformers and a plurality of common transformers;
a square wave controller for outputting a control signal to the square wave switch;
a plurality of lamps each having two ends coupled with the plurality of starting transformers and the plurality of common transformers respectively via high voltage capacitive elements;
the plurality of starting transformer having their primary sides connected in series, the square wave switch outputting the AC signal to the two ends of the primary sides of the plurality of cascaded starting transformers, the secondary sides of the plurality of starting transformers each having a first end connecting to high voltage capacitive elements and a first capacitor and outputting a sinusoidal wave, and a second end connecting to a reference voltage level; when the primary sides of the starting transformers are connected in series, a same input current will flow through the primary sides of the starting transformers;
therefore a same output current will flow out of each secondary side of the starting transformers; and
the plurality of common transformers having their primary sides connected in series, the square wave switch outputting the AC signal to the two ends of the primary sides of the plurality of cascaded common transformers, the secondary sides of the plurality of common transformers each having a first end connecting to high voltage capacitive elements and a second capacitor and outputting an inverse sinusoidal wave, and a second end connecting to the reference voltage level; when the primary sides of the common transformers are connected in series, a same input current will flow through the primary sides of the starting transformers; therefore a same output current will flow out of each secondary side of the starting transformers.

2. The lamp driving device as claimed in claim 1, wherein each starting transformer having a same turn ratio for its first and secondary sides.

3. The lamp driving device as claimed in claim 1, wherein each common transformer having a same turn ratio for its first and secondary sides.

4. A lamp driving device comprising:
a DC power supply for outputting an DC signal to a square wave switch;
the square wave switch for converting the DC signal into an AC signal and outputting the AC signal to a plurality of starting transformers and a plurality of common transformers;
a square wave controller for outputting a control signal to the square wave switch;
a plurality of lamps each having two ends coupled with the plurality of starting transformers and the plurality of common transformers respectively via high voltage capacitive elements;
the plurality of starting transformers having their secondary sides connected in series, wherein a first end of a secondary side of a first starting transformer connects to high voltage capacitive elements and a first capacitor and outputs a sinusoidal wave, a first end of a secondary side of a last starting transformer connects to a reference voltage level, and the primary sides of the starting transformers are connected in parallel and are connected to the square wave switch, which outputs the AC signal to the two ends of the primary sides of the starting transformers, since the secondary sides of the starting transformers are connected in series; therefore each starting transformer outputs a similar amount of power; and
the plurality of common transformers having their secondary sides connected in series, wherein a first end of a secondary side of a first common transformer connects to high voltage capacitive elements and a second capacitor and outputs an inverse sinusoidal wave, a first end of a secondary side of a last common transformer connects to a reference voltage level, and the primary sides of the common transformers are connected in parallel and are connected to the square wave switch, which outputs the AC signal to the two ends of the primary sides of the common transformers, since the secondary sides of the common transformers are connected in series; therefore each common transformer outputs a similar amount of power.
